(19) United States
(12) Patent Application Publication
(10) Pub. No.: US 2007/0248749 A1
(43) Pub. Date: Oct. 25, 2007

(54) Reducing pad burnish damages on magnetic recording media with mixed low molecular weight free lubricant

(75) Inventors: Xing-Cai Guo, Tracy, CA (US); Yun-Lin Hsiao, San Jose, CA (US); Thomas Edward Karis, Aromas, CA (US); Bruno Marchon, Palo Alto, CA (US); Ullal Vasant Nayak, San Jose, CA (US); Bing K. Yen, Cupertino, CA (US)

Correspondence Address: MINTZ, LEVIN, COHN, FERRIS, GLOVSKY AND POPEO, P.C, 1400 PAGE MILL ROAD, PALO ALTO, CA, 94304-1124, US

(73) Assignee: Hitachi Global Storge Technologies Netherlands, B.V.

(21) Appl. No.: 11/407,720

(22) Filed: Apr. 19, 2006

(51) Int. Cl. B05D 5/12

(52) U.S. Cl. 427/127

(57) ABSTRACT

The present invention provides a novel method for reducing pad burnish damages on magnetic recording media. The method of the present invention reduces burnish damage and increases glide yield without compromising disk flyability, durability and general quality.

### TECHNICAL FIELD

This invention relates generally to magnetic storage media, and in particular to reducing pad burnish damage to magnetic storage media.

### BACKGROUND OF THE INVENTION

This invention relates to magnetic storage media and in particular to rigid magnetic disks used in hard disk drives.

Hard disk drives read from and write to magnetic flux patterns on magnetic media. Hard disk drives have been used for over forty years to store digital data, and offer low cost, high recording capacity, and relatively rapid data retrieval. While the basic principle of reading and writing magnetic patterns on rotating disks remains the same, components of the disk drive, particularly the read-write head (“head”) and the disks have significantly evolved.

The first disks were made by coating a rigid platter, as large as 24 inches in diameter, with magnetic particles, such as iron oxide particles, mixed in a resin. More recently, thin-film technology has been used to sputter a thin film of magnetic metal on a platter that is typically about 3.5 inches in diameter. A metallic film offers 100 times the magnetization of the older, particulate films, thereby producing the same amount of magnetic flux from a much thinner film. A thinner film allows more narrow magnetic cells, which represent a data bit, to be formed. The narrower magnetic cell results in higher recording and storage densities. Additionally, a metallic thin film may be formed on a very smooth platter. Smooth films allow the head to “fly” closer to the magnetic cells, yielding higher read-back amplitudes.

Surface roughness limits how low a head can approach the media, and adds to the overall contribution of noise from the magnetic layer. Advancements in the design of recording heads, particularly the introduction of magneto-resistive (MR) heads, have required continuing reductions in surface roughness. Current MR media, capable of storing recording densities of 3 Gbit/in² have surfaces with roughness values of about 1 nm. In the future, with data densities as high as 10 Gbit/in², surface roughness are likely to be an order of magnitude less than that of current media.

Pad burnish is an essential process in manufacturing magnetic recording media following sputter deposition of magnetic layers/overcoat and lubricant dipping. The purpose of pad burnish is to polish off high asperities on the disk surface and thus to increase glide yield. However, poor burnish often damages the disk by causing overcoat scratches and producing solid particles, which leads to poor corrosion resistance and low glide yield. It has been known that a minimum amount of mobile (unbonded) lubricant is required to minimize damage to the disk, exemplified by the glide yield versus time delay of sputter-to-lube or lube-to-burnish (FIG. 1). Longer sputter-to-lube delay decreases the initial bonded fraction of lubricant (due to contamination of water and organics), whereas longer lube-to-burnish delay increases the bonded fraction (governed by lubricant bonding kinetics). Therefore, longer sputter-to-lube delay and shorter lube-to-burnish delay produce high glide yield.

However, too much free lubricant causes severe flyability problems, such as lube pick-ups, moguls and depletion, and also reduces magnetic clearance. The subsequent flyability tests or drive build require less free lubricant. The total lubricant thickness is limited in order to reduce magnetic spacing and achieve high areal density. The present invention provides a solution to the paradoxical requirements on the amount of free lubricants without complicating current manufacture procedures.

Other attempts at solving the same problem are surprisingly complex. For example, in U.S. Pat. No. 6,521,286, entitled “Method for Manufacturing a Magnetic Recording Medium,” a lubricating layer is applied to the surface of a thin protective layer on a magnetic recording medium. Thereafter the protective layer is burnished to remove asperities from the surface thereof. The lubricant layer is removed by solvent washing. Then a replacement lubricant layer is deposited on the surface of the protective layer. The present invention is directed to a single step, mixed free lubricant process which does not complicate the manufacturing process nor add additional costs. The multiple step process taught by the reference complicates the manufacturing process, reduces throughput, increases costs and introduces the potential for media contamination.

Other references considered by applicant failed to address the burnish damage problem. For example, U.S. Pat. No. 6,168,831, entitled “Apparatus for Differential Zone Lubrication of Magnetic Recording Media and Related Methods,” discloses the use of mixed high molecular weight (MW) lubricants to produce dual-zone (data zone and landing zone) lubricated disks. The mobile lubricant is removed from the data zone by absorbent tapes, not by evaporation. U.S. Pat. No. 6,168,831, entitled “Magnetic Recording Medium Having a Lubricant film Consisting of a Mixture of Two Lubricants and which has Two Peaks of Molecular Weight,” discloses the use of two high MW lubricants with different functional groups to improve sliding tolerance, for example. EP 505303, entitled “Lubricant for Magnetic Recording Disks,” discusses the use of two high MW lubricants with different mobility to improve tribological performance. The IEEE paper entitled “Duplex Reactive Fluorocarbon Films with Spin-Off Resistant Characteristics,” Vol. Mag-23, No. 1, January 1987, discusses the use of two high MW lubricants to reduce spin-off, i.e. lubricant depletion.

### SUMMARY OF THE INVENTION

The present invention is addressed to the aforementioned need in the art, and provides a novel method for reducing pad burnish damages on magnetic recording media. A first low molecular weight non-functional free lubricant is mixed with a second high molecular weight lubricant. The total lubricant thickness is increased in order to benefit the burnish process to follow. The low molecular weight free lubricant evaporates from the disk at ambient temperatures during post-lube treatment and before glide and flyability tests or drive build, leaving a thin layer of highly bonded, high molecular weight lubricant on the disk surface. The method of the present invention reduces burnish damage and increases glide yield without compromising disk flyability, durability and general quality.

### BRIEF DESCRIPTION OF THE DRAWINGS

FIG. 1 provides a graphical illustration of glide yield when compared to time delay of sputter-to-lube or of lube-to-burnish.

FIG. 2A shows a schematic representation of the present invention in which a mixed lubricant has been applied to the surface of a magnetic disk prior to burnish;

FIG. 2B shows the a schematic representation similar to that shown in FIG. 2A, after a burnish cycle has been completed; and

FIG. 2C shows the a schematic representation similar to that shown in FIG. 2B, following the burnish cycle as well as post-lube treatment of the disk, allowing evaporation of the low molecular weight (MW) lubricant from the mixed lubricant applied to the magnetic disk prior to burnish.

FIG. 3 is a graphical representation of that portion of the method of the invention relating to separation of mixed lubricants by evaporation in which a number of lubricant mixtures were each applied to the surface of a respective disk, and evaporation times for the lower MW lubricant were observed.

FIG. 4 is a graphical representation comparing friction forces encountered during burnish.

FIG. 5 is a comparison of the friction forces during burnishing of a disk with a high MW lubricant (FIG. 5A) to a disk using a mixed lubricant (FIG. 5B).

FIG. 6 compares a mixed free lubricant burnish with a prior art burnish in terms of corrosion counts.

### DETAILED DESCRIPTION OF THE INVENTION

Definitions and Overview:

Before describing the present invention in detail, it is to be understood that this invention is not limited to specific methods, processes, or device structures, as such may vary. It is also to be understood that the terminology used herein is for the purpose of describing particular embodiments only, and is not intended to be limiting.

It must be noted that, as used in this specification and the appended claims, the singular forms “a,” “an,” and “the” include both singular and plural referents unless the context clearly dictates otherwise. Thus, for example, reference to “a disk” includes a plurality of disks as well as a single disk; reference to “a characteristic” includes a plurality of characteristics as well as single characteristic, and the like.

In describing and claiming the present invention, the following terminology will be used in accordance with the definitions set out below.

A “hard disk drive” (HDD, or also hard drive) is a non-volatile data storage device that stores data on a magnetic surface layered onto hard disk platters.

The term “CMP” refers to chemical mechanical polishing, a process for the removal of surface material from a disk or wafer. The process uses chemical and mechanical actions to achieve a mirror-like surface for subsequent processing.

The term “DLC” or diamond-like carbon refers to many new forms of carbon which have both graphitic and diamond-like characteristics. DLC has many possible material properties as it becomes more diamond-like and crystalline. Its density is between graphite and diamond (2.2-3.5 grams/cubic centimeter). The optical properties are diamond-like in index of refraction but a high extinction coefficient makes them dark. DLC is being used in the semiconductor industry and as a wear resistant coating for disks used in hard disk drives.

The term “asperity” refers to a peak above the mean roughness of the disk surface. Disk asperities can result in disk failure. During disk testing test parameters such as glide height (the fly height of the glide head) and glide hits (the number of hits which occur during glide testing) are adjusted and controlled for different head designs in different HDD products.

The term “flyability” refers to a performance criterion for a magnetic disk; the ability of a read/write head to travel over a disk surface in an operative mode, i.e. a read/write mode, for a substantial period of time without interference from asperities on the

The term “glide yield” refers to a measure of disk failure when the disk surface is tested with a glide head for asperities: (disks tested−disks failed)/disks tested*100=glide yield (%).

The term “high molecular weight” or “high MW” lubricant refers to lubricants that range in molecular weight from 2000 to 10000. Examples of high MW lubricants are ZTMD (molecular weight=2460) manufactured by Hitachi and Z-Tetraol manufactured by Solvay Solexis, of Thorofare, N.J. If a mixture of a high MW lubricant with strong bonding properties and a low MW free lubricant were applied to a coated magnetic disk, the combination is particularly useful during the burnish cycle of the disk manufacturing process, first to protect the disk during burnish, then to provide a lubricated surface following burnish, when the bonded high MW lubricant remains attached to the disk, improving glide yield and flyability.

The term “longitudinal recording” refers to recording on a collection of magnetized particles having their respective north and south poles lined parallel to a disk's surface in a ring around its center. In a magnetic disc drive, digital information (expressed as combinations of “0's” and “1's”) is written on tiny magnetic bits (which themselves are made up of many even smaller grains). When a bit is written, a magnetic field produced by the disc drive's read/write head orients the bit's magnetization in a particular direction, corresponding to either a 0 or 1. The magnetism in the head in essence “flips” the magnetization in the bit between two stable orientations.

The term “low molecular weight” or “low MW” lubricant refers to lubricants that range in molecular weight from 500-1900. Examples of low MW lubricants are Z950, Z1080, Z1330 and Z1650 fractionated by supercritical fluid extraction from Z15 manufactured by Solvay Solexis, of Thorofare, N.J. The lubricants tend to slowly evaporate at ambient temperatures or temperatures slightly elevated above ambient temperatures within a few hours to a few days.

“Optional” or “optionally” means that the subsequently described circumstance may or may not occur; so that the description includes instances where the circumstance occurs and instances where it does not.

The term “perpendicular recording” refers to data recording on a hard disk in which the poles of the magnetic bits on the disk are aligned perpendicularly to the surface of the disk platter. Perpendicular recording can deliver up to 10 times the storage density of longitudinal recording, on the same recording media. Current hard disk technology with longitudinal recording has an estimated limit of 250 Gbit/sq. inch (38 Gbit/cm²) due to the superparamagnetic effect. The energy threshold for flipping bits that are smaller than this is equal to the thermal energy present in the disk, causing random data corruption, thus limiting the minimum bit size, and the storage density of disks employing current hard disk technology. Perpendicular recording gets around the limit by re-aligning the poles of the bits perpendicularly to the surface of the disk so they can be placed closer together on the platter, thus increasing storage density by a factor of 10.

The term “substantially” as in, for example, the phrase “substantially identical elements,” refers to elements that do not deviate by more than 10%, preferably not more than 5%, more preferably not more than 1%, and most preferably at most 0.1% from each other. Similarly, the phrase “substantially identical elements” refers to elements that do not deviate in physical properties. For example “substantially identical elements” differ by more than 10%, preferably not more than 5%, more preferably not more than 1%, and most preferably at most 0.1% from each other. Other uses of the term “substantially” involve an analogous definition.

The term “substrate” as used herein refers to any material having a surface onto which a coating may be applied. In the preferred embodiment of the present invention the substrate is a disk having a magnetic coating and used in a data storage device such as a disk drive.

The term “superparamagnetic effect” refers to a phenomenon observed in very fine particles, where the energy required to change the direction of the magnetic moment of a particle is comparable to the ambient thermal energy. At this point, the rate at which the particles will randomly reverse direction becomes significant. This is particularly important in the field of hard disk technology, where the superparamagnetic effect limits the minimum size of particles that can be used, and consequently the data densities possible. Current estimates suggest a limit of 250 Gigabit/square inch (38 Gbit/cm²) are possible using current hard disk geometries. One suggested technique to further extend recording densities on hard disks is to use perpendicular recording rather than conventional longitudinal recording. This changes the geometry of the disk and alters the strength of the superparamagnetic effect.

The present invention provides a novel method for reducing pad burnish damages on magnetic recording media wherein a first low molecular weight non-functional free lubricant is mixed with a second high molecular weight lubricant. The lubricant mixture is applied to the read/write surface of magnetic recording disk. The total lubricant thickness is increased in order to benefit the burnish process to follow. The disk surface is then burnished to remove asperities there from. The low molecular weight free lubricant evaporates from the disk at ambient temperatures following burnish and during post-lube treatment and before glide and flyability tests or drive build, leaving a thin layer of highly bonded, high molecular weight lubricant on the disk surface. The method of the present invention reduces burnish damage and increases glide yield without compromising disk flyability, durability and general quality.

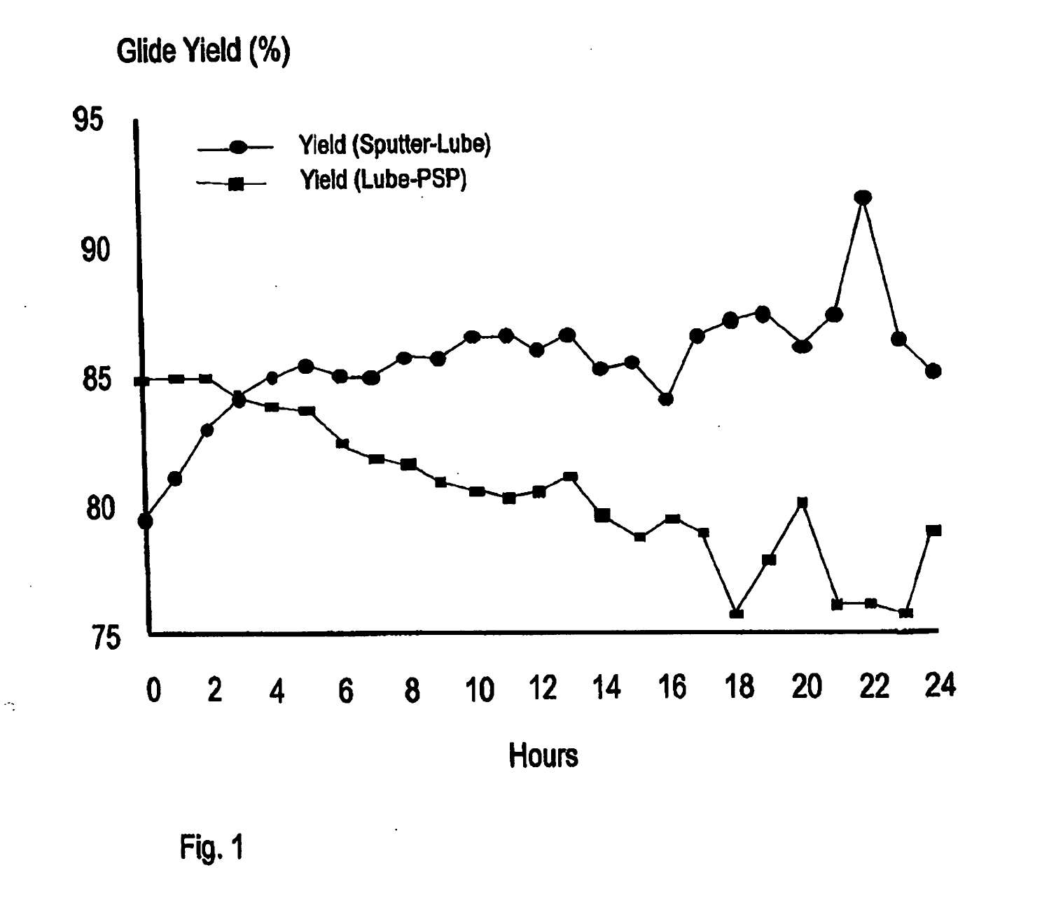

Pad burnish is an essential process in manufacturing magnetic recording media following sputter deposition of magnetic layers, a protective overcoat and lubricant dipping. The purpose of pad burnish is to polish off high asperities on the disk surface and thus to increase glide yield. However, poor burnish often damages the disk by causing overcoat scratches and producing solid particles, which leads to poor corrosion resistance and low glide yield. A minimum amount of mobile (unbonded) lubricant is required to minimize damage to the disk, exemplified by the glide yield versus time delay of sputter-to-lube or lube-to-burnish (FIG. 1). Longer sputter-to-lube delay, as shown in the upper curve of FIG. 1 decreases the initial bonded fraction of lubricant (due to contamination of water and organics), whereas longer lube-to-burnish delay, as shown in the lower curve of FIG. 1, increases the bonded fraction (governed by lubricant bonding kinetics). Therefore, longer sputter-to-lube delay and shorter lube-to-burnish delay produce high glide yield.

However, too much free lubricant causes severe flyability problems, such as lube pick-ups, moguls and depletion, and also reduces magnetic clearance. The subsequent flyability tests or drive build require less free lubricant. The total lubricant thickness is limited in order to reduce magnetic spacing and achieve high areal density. The present invention provides a solution to the paradoxical requirements on the amount of free lubricants without complicating current manufacture procedures.

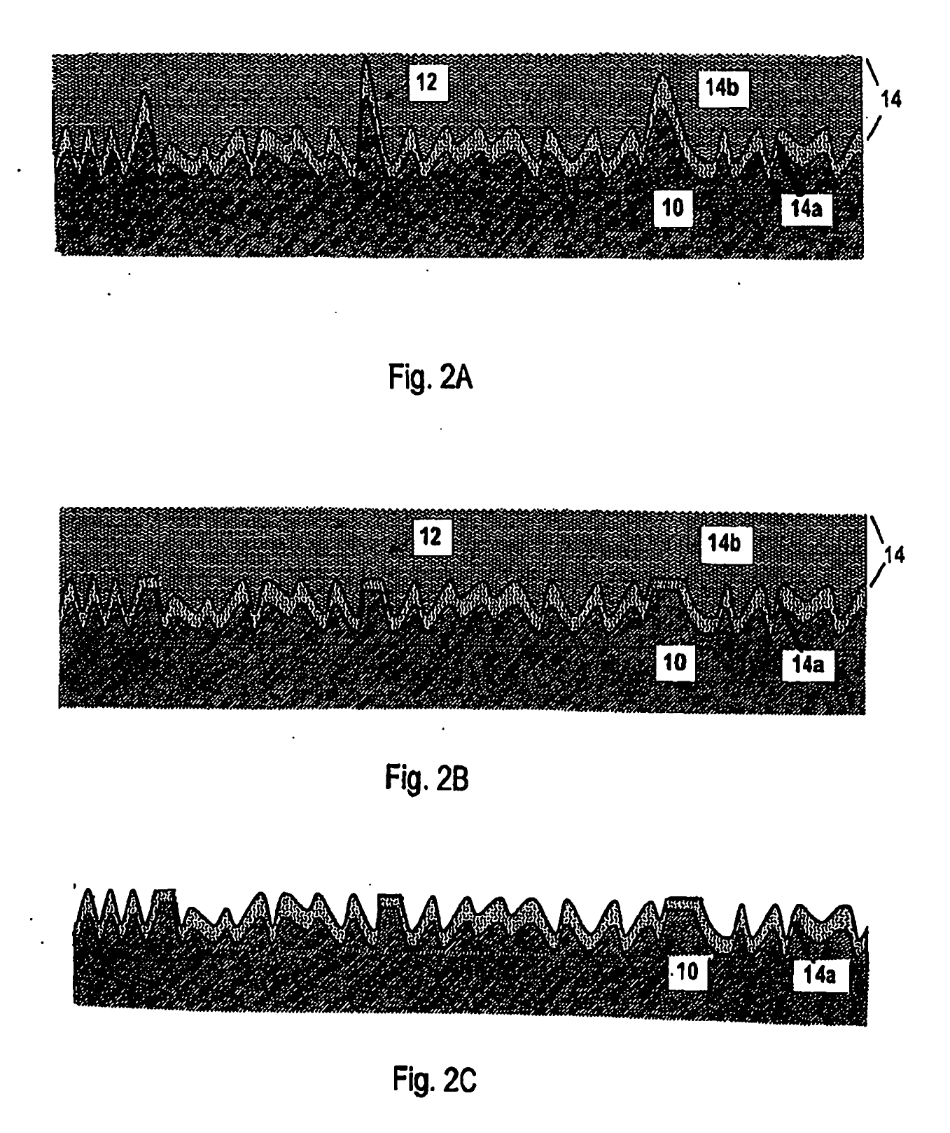

The basic principles associated with the method of the present invention are schematically illustrated in FIG. 2. The view in FIG. 2A is a cross sectional view, taken through a portion of a magnetic recording media, i.e. a read/write disk which is part of a hard disk drive (HDD) assembly. FIG. 2A does not show the disk substrate or the layer of magnetic material deposited on the substrate, but rather shows its uppermost layer as the diamond-like carbon (DLC) overcoat 10 which typically overlies the layer of magnetic material deposited on the substrate. Although the DLC layer 10 typically comprises very small carbon particles deposited on the disk in plasma form, anomalies in the deposition method for DLC can create asperities 12 which project upwardly from the disk surface. If such asperities 12 were to remain on the overcoat 10, and such disk were installed in a HDD, the read/write head of the HDD could collide with the asperities 12 during its data collection cycle and cause loss of data and/or disk failure.

To minimize asperities 12, the HDD manufacturer typically subjects the DLC overcoat 10 of the disk to a burnish cycle in which the DLC overcoat 10 is buffed using a burnish pad and abrasive tape to smooth the DLC overcoat 10 and remove asperities 12 there from.

Of course the burnish cycle does not involve dry buffing of the DLC overcoat, since dry buffing to likely to increase surface roughness, not reduce it. Accordingly, prior to burnish, a lubricant layer 14 is applied to the DLC overcoat 10. The depth of the lubricant layer 14 is sufficient to substantially cover all of the asperities 12 in the DLC overcoat 10. The lubricant to be used in the preferred method of the present invention is a mixture of a high molecular weight (MW) free and bonded non-volatile lubricant 16 and a low MW volatile free lubricant 18.

The preferred mixture is a high MW lubricant with good bonding properties such as ZTMD, a lubricant developed by assignee. A commercially available high MW lubricant usable in the present application is Z-Tetraol, manufactured by Solvay Solexis, of Thorofare, N.J. The low MW lubricant with a low bonded ratio used in the mixture shown in FIG. 2 is Fomblin Z. Other similar low MW lubricants include Z and Z-dol, also available from Solvay.

As seen in FIG. 2A, a high MW lubricant layer 14a bonds to the DLC overcoat 10, with a free low MW lubricant layer 14b tending to separate from the mixture 14 to generally overlie the layer 14a.

As seen in FIG. 2B, the lubricant mixture 14 facilitates the burnish process, enabling the burnish pad to knock down and smooth asperities 12 in the DLC overcoat 10 while protecting the surface of the overcoat 10 from being roiled during the burnish process. During the burnish process, a portion of the low MW layer 14b is removed, either through evaporation or by the burnish process itself.

Following burnish, as seen in FIG. 2C, the remaining low MW lubricant evaporates from the disk at ambient temperatures or during post-lube treatment, leaving only the layer 14a of highly bonded, high MW lubricant on the DLC overcoat of the disk.

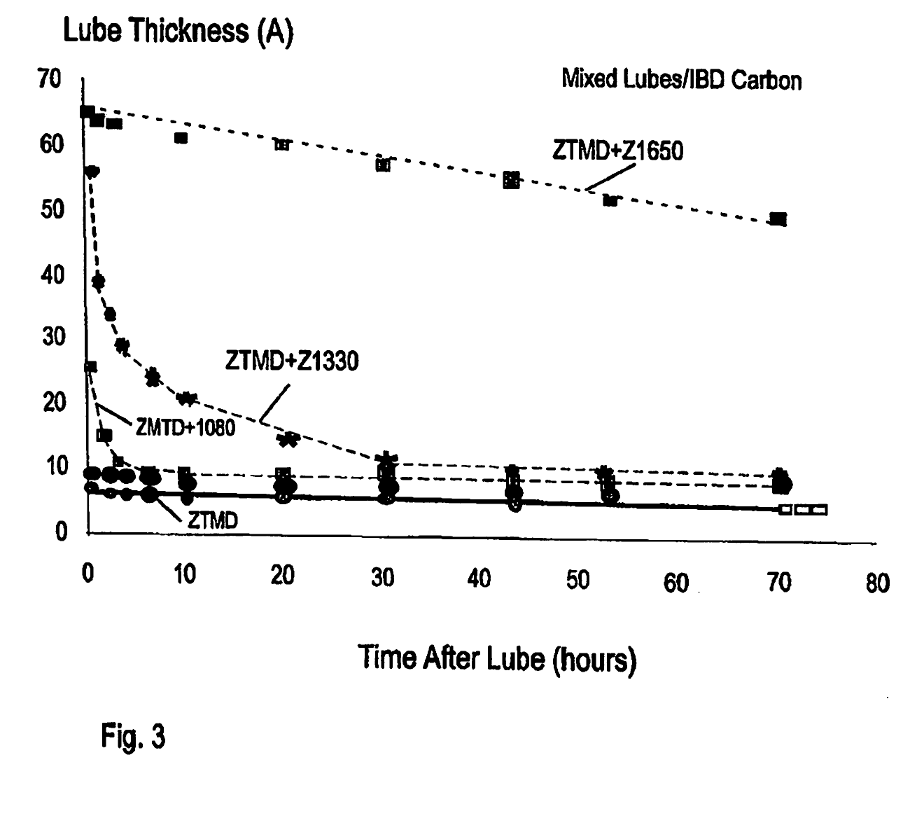

FIG. 3 demonstrates the implementation of the present invention. As shown in FIG. 3, the total lubricant thickness of certain lubricant mixtures after lubricant dipping was monitored as a function of time using an infrared spectrometer. Four types of non-functional Fomblin Z lubricants of various molecular weights (950, 1080, 1330 and 1650) were each mixed with ZTMD (molecular weight=2460) Disks having a protective DLC overcoat were dipped in each of the mixtures. As time elapses, the low MW non-functional Z lubricants evaporate from the disks. After three hours the Z950 and Z1080 lubricants have evaporated from the disks. Although the Z1330 and Z1650 lubricants do remain on the disks much longer, eventually all low MW, free lubricants have completely evaporated from the disks, leaving only the same bonded fraction of ZTMD on each of the disks.

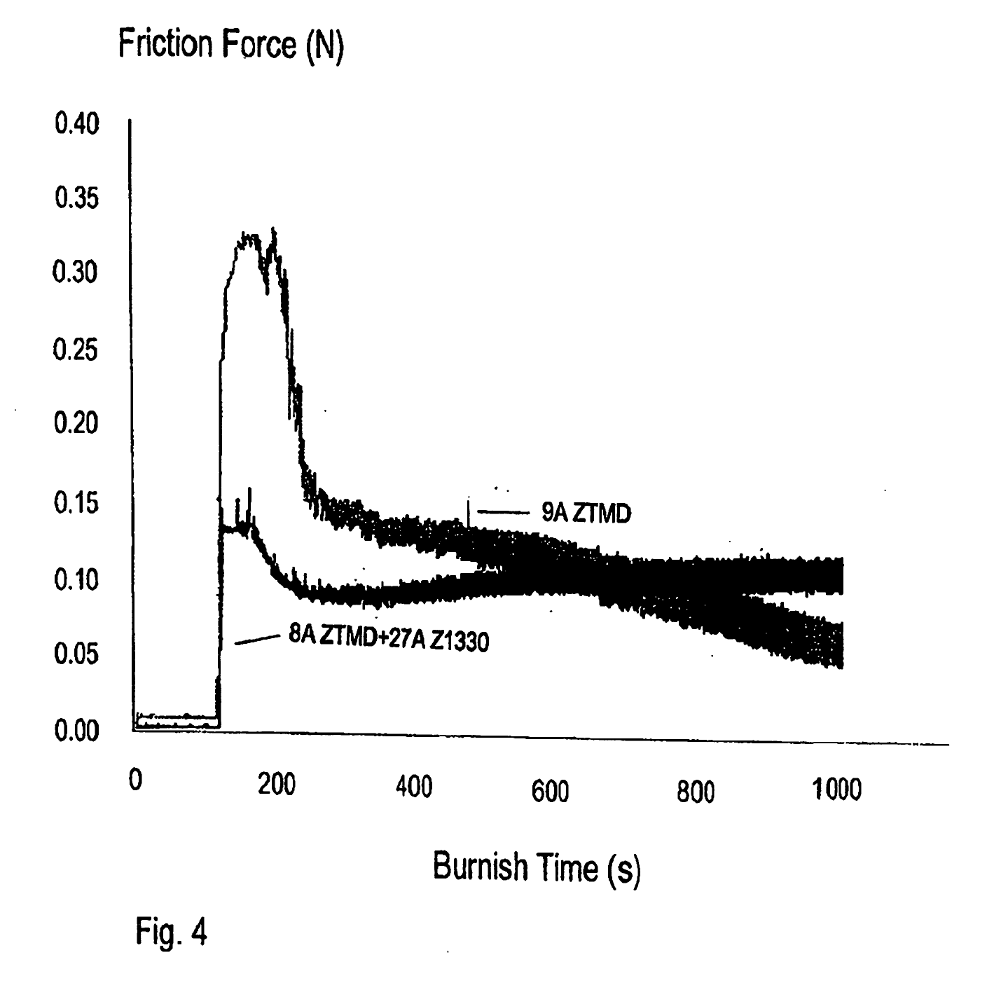

FIG. 4 displays a comparison of friction forces during pad burnish, each at 24.8 kPa and 4000 rpm, using a 0.5 micron abrasive tape and foam pad material. Pad friction is clearly reduced by the presence of the low MW Z1330 in the lubricant mixture, and the resultant positive influence the mixture has on the burnish process. Although FIG. 4 shows a decline in friction for the ZTMD lubed disk at extended burnish times, such decline is likely due to wear induced by the burnish process, and not the choice of lubricant.

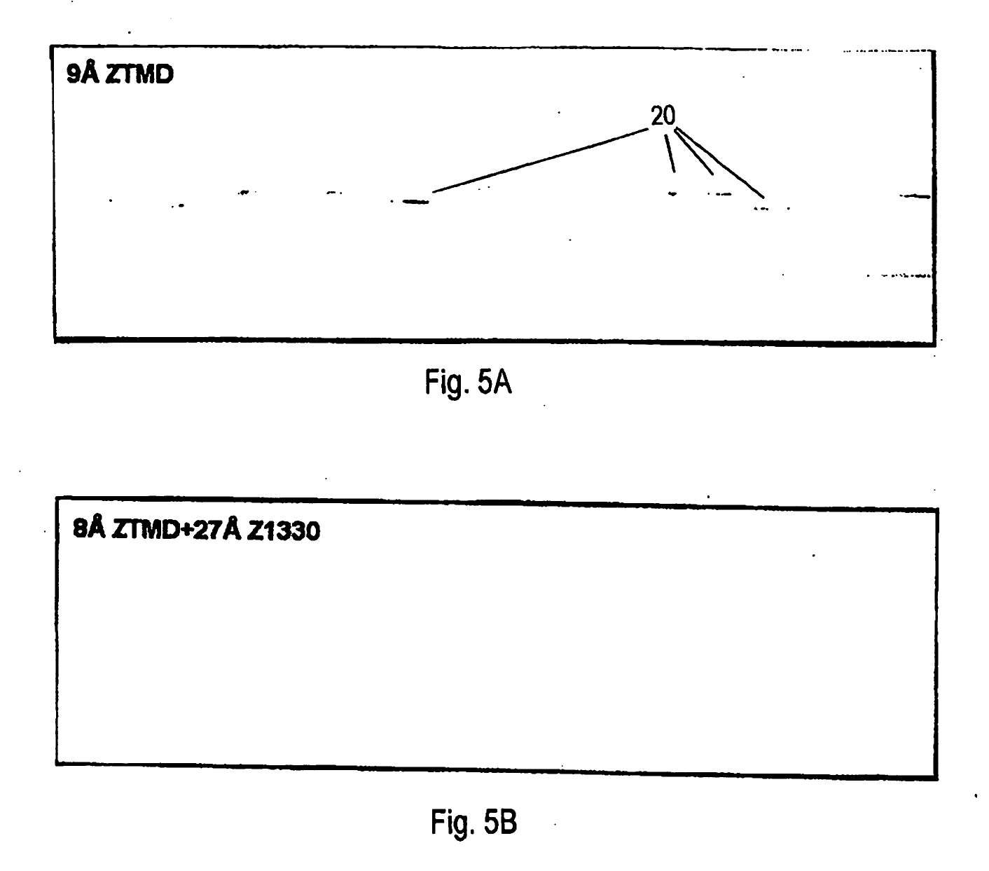

FIG. 5 provides two optical surface analyzer (OSA) images of disks at 4 μm resolution after pad burnish. Burnish damage are clearly visible as scratches 20 on the ZTMD-lubed (upper) disk shown in FIG. 5A, whereas no damage is seen on the (lower) disk with the lubricant mixture of ZTMD and Z1330 shown in FIG. 5B. Additional testing showed similar results between the two cases shown here.

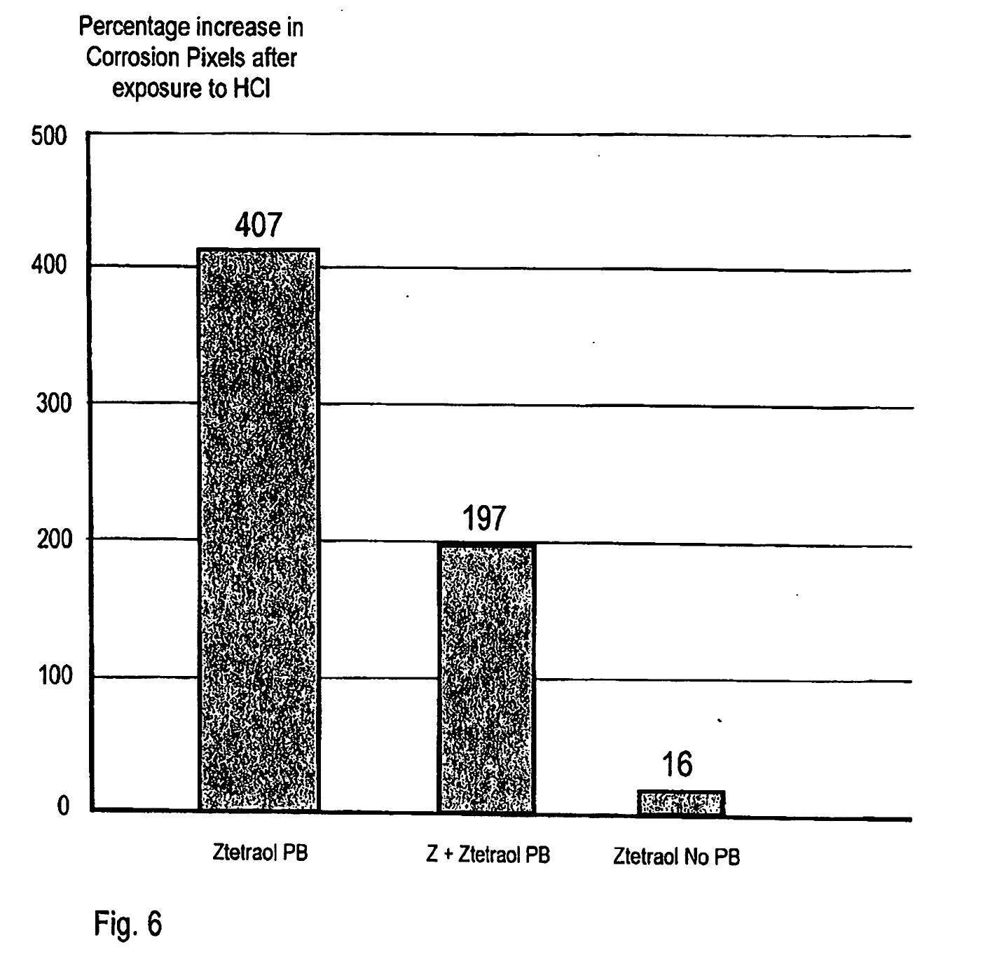

FIG. 6 is further evidence of the efficacy of the preferred method, showing a substantial reduction in corrosion for mixed lubricant burnish when compared to the prior art burnish. The chart of FIG. 6 shows the percentage increase in corrosion pixels for a series of disks after thirty minutes exposure to hydrochloric acid (HCl), the first group of disks burnished using the lubricant Ztetraol PB, the second group of disks burnished using the lubricants Z+Ztetraol PB, and the third group of disks burnished using the lubricant Ztetraol with No PB.

Lubricant described herein may be used with any media utilized in the hard disk drive industry including longitudinal, perpendicular and patterned media.

It is to be understood that while the invention has been described in conjunction with the preferred specific embodiments thereof, that the foregoing description as well as the examples that follow are intended to illustrate and not limit the scope of the invention. Other aspects, advantages and modifications within the scope of the invention will be apparent to those skilled in the art to which the invention pertains.

All patents, patent applications, and publications mentioned herein are hereby incorporated by reference in their entireties.

We claim:

1. A method for reducing pad burnish damages on magnetic recording media comprises:
mixing a first low molecular weight lubricant with a second high molecular weight lubricant; and
evaporating the low molecular weight lubricant from the disk following burnish; and
leaving a thin layer of high molecular weight lubricant on the disk surface.

2. The method of claim 1 wherein the low molecular weight lubricant is a free lubricant.

3. The method of claim 2 wherein the low molecular weight free lubricant is readily evaporable at ambient and slightly elevated from ambient temperatures.

4. The method of claim 3 wherein the low molecular weight free lubricant has a molecular weight in the range of 500 to 1900.

5. The method of claim 4 wherein the low molecular weight lubricant is Z950.

6. The method of claim 4 wherein the low molecular weight lubricant is Z1080.

7. The method of claim 4 wherein the low molecular weight lubricant is Z1330.

8. The method of claim 4 wherein the low molecular weight lubricant is Z1650.

9. The method of claim 1 wherein the high molecular weight lubricant has high bonding capabilities.

10. The method of claim 9 wherein the high molecular weight, high bonding lubricant has a molecular weight in the range of 2000 to 10000.

11. The method of claim 10 wherein the high molecular weight, high bonding lubricant has a molecular weight of 2000 to 10000 and the low molecular weight lubricant has a molecular weight in the range of 500 to 1900.

12. The method of claim 10 wherein the high molecular weight, high bonding lubricant is Fomblin Z.

13. The method of claim 10 wherein the high molecular weight, high bonding lubricant is Z-tetraol.

14. The method of claim 1 wherein the magnetic recording media is longitudinal recording media.

15. The method of claim 1 wherein the magnetic recording media is perpendicular recording media.

16. The method of claim 1 wherein the magnetic recording media is patterned recording media.

17. A method for reducing pad burnish damages on magnetic recording media comprises:
providing a first low molecular weight non-functional free lubricant;
providing a second high molecular weight lubricant;
mixing said first and second lubricants;
applying the lubricant mixture to the read/write surface of a magnetic recording disk;
increasing the total lubricant thickness in order to benefit the burnish process to follow;
burnishing the disk surface to remove asperities there from;
enabling the low molecular weight free lubricant to evaporate from the disk following burnish, leaving a thin layer of highly bonded, high molecular weight lubricant on the disk surface thereby reducing burnish damage and increasing glide yield without compromising disk flyability, durability and general quality.

18. The method of claim 17 wherein the low molecular weight free lubricant evaporates during post lube treatment.
